(19) United States
(12) Patent Application Publication
(10) Pub. No.: US 2006/0100886 A1
(43) Pub. Date: May 11, 2006

(54) Telematics service method

(76) Inventor: Anthony Luke Simon, West Bloomfield, MI (US)

Correspondence Address: ANTHONY LUKE SIMON;General Motors Corporation, Legal Staff, Mail Code 482-C23-B21, P.O. Box 300, Detroit, MI, 48265-3000, US

(21) Appl. No.: 10/984,001

(22) Filed: Nov. 8, 2004

(51) Int. Cl. G06Q 99/00

(52) U.S. Cl. 705/1

(57) ABSTRACT

A telematics service method comprising the steps of: monitoring vehicle location; inferring vehicle title transfer from the monitored vehicle location, wherein the monitoring and inferring steps are performed autonomously in the vehicle.

### TECHNICAL FIELD

This invention relates to a method and system for telematics service.

### BACKGROUND OF THE INVENTION

Many vehicles contain equipment for delivering telematics services. Telematics services vary among service providers and in typical examples include communicating with a vehicle to provide safety and/or convenience services according to many known methods.

When a vehicle is sold as a used vehicle, it may be difficult to learn who the buyer of the new vehicle is. Many states that have vehicle registration data restrict use of state records to exclude marketing activities. Thus an alternative method of marketing to purchasers of used cars with in-vehicle telematics equipment is desired.

### SUMMARY OF THE INVENTION

Advantageously, this invention provides a telematics service method according to claim 1.

Advantageously, according to one example, this invention provides a telematics service method comprising the steps of monitoring vehicle location and inferring vehicle title transfer responsive to the monitored vehicle location, wherein the monitoring and inferring steps are performed autonomously in the vehicle

Advantageously, according to a preferred example, this invention provides a telematics service method comprising the steps of: first monitoring vehicle location; second monitoring usage of the telematics service; inferring vehicle title transfer responsive to the monitored vehicle location and the monitored usage; and activating an in-vehicle function in response to the inferred vehicle title transfer. According to a preferred example, upon activation, the in-vehicle function communicates to a user of the vehicle that telematics services are available and suggests an action through which the user may subscribe to telematics services.

### DESCRIPTION OF THE DRAWINGS

FIG. 1 illustrates example method steps for implementing this invention; and

FIGS. 2, 3, 4 and 5 illustrate example steps for implementing the method of FIG. 1.

### DESCRIPTION OF AN EXEMPLARY EMBODIMENT

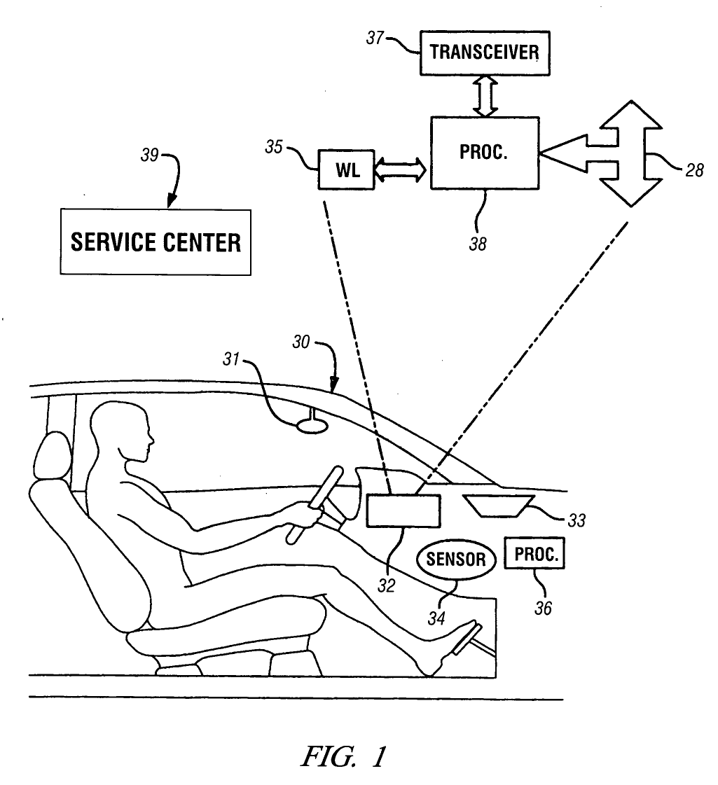

Referring to FIG. 1, the vehicle 30 includes a telematics unit 32, with its internal processor 38 coupled to a GPS unit or other type of location unit 35 for identifying the location of the vehicle. The telematics unit 32 may also include its own transceiver 37 for communicating through the wireless telecommunications network, but transceiver 37 is optional if the system designer desires that a separate wireless transceiver (not shown) be the system's primary device for communicating with the wireless telecommunications network. It is also noted that transceivers can be utilized to determine location through known methods (such as triangulation from fixed antennas on the network) that need not be explained in detail herein. If the transceiver is utilized to determine location, then unit 37 may perform the functions of both the transceiver and the location unit.

The processor 38 is coupled to an automotive bus 28 (of any known type, including but not limited to Class II, LAN, or other hardwired bus or any functional wireless bus) for communicating with other in-vehicle processors 36 and/or sensors 34 for performing known telematics services functions. The telematics unit 32 also interfaces with the vehicle audio system (represented by speaker 33), to broadcast audible messages to the vehicle user(s) and receive inputs from one or more in-cabin microphones 31 and/or buttons or keypads (not shown). Additionally, a visual display and keyboard or touch screen may be included in the vehicle for interfacing the telematics unit 32 and the vehicle operator.

In operation the processor 38 runs a program that periodically receives location information from location unit 35. The processor detects vehicle shutdown and, before going into sleep mode with the vehicle shut down, stores the location of the vehicle at shutdown into non-volatile memory. The processor 38 also stores in memory the home location of the vehicle. This is typically a geo-coded location representing the vehicle owner's home address. This may be downloaded to the vehicle when the owner subscribes to telematics services or purchases a vehicle with subscription services included in the price of the new vehicle.

At each shutdown, the location is compared to the “home” location. If the location at shut down is different from the “home” location, then the system begins tracking the number of consecutive days of vehicle shutdown away from the “home” location.

In this example, the system also monitors the usage of the telematics system by the vehicle user, recording the last date and time of use.

The home location monitoring acts as a long-term step filter. If the system detects a new “home” location, that is, for example, the system consistently detects a new location or locations different from the most previous “home” location, the system infers that the vehicle has a new home location at a new residence. A new residence is consistent with a vehicle title transfer and the vehicle having a new owner.

An inference of title transfer thus can be drawn from the vehicle having a new residence, or from a vehicle being started, moved and shut down for a predetermined number of consecutive days away from the home location. To increase accuracy of the inference, the usage of the telematics services is also preferably monitored. If the telematics service has not been used since the vehicle has moved from the previous “home” location to the new home location, then this is consistent with the vehicle having a new owner not familiar with the telematics service available for the vehicle. Thus an inference of title transfer can be drawn from the vehicle having a new residence in combination with the telematics service remaining unused for a sufficient period of time.

Upon determining an inference of vehicle title transfer, an in-vehicle device is activated. For example, the telematics unit 32 is activated to take an action marketing the telematics services to the new vehicle owner. In one implementation, upon determining inference of vehicle title transfer, at the next start-up of the vehicle, the telematics unit plays an audio message to the user of the vehicle indicating the availability of telematics services for the vehicle. The audio message suggests an action through which the user may subscribe to telematics services, for example, by pressing the telematics services button (not shown) to initiate a connection between the in-vehicle telematics unit and a service center 39. The audio message can be set to play a predetermined number of times after subsequent start-ups. If the user responds to the message, for example, by pressing the telematics services button, no further message playbacks will occur.

If the user responds to the audio message by pressing the telematics services button, the connection to the service center 39 is made utilizing the transceiver 37. For example, the connection is a cellular, PCS, GSM, 3G or 4G (or any other) communication or call. The call can include data or be made to a special-purpose phone number so that the service center 39 telephony system detects that the incoming call is made after inference of a title transfer. The telephony system signals this fact to the operator who answers the call, or otherwise plays automated messages designed to assist service subscription. If an operator handles the call, the operator can ask the vehicle user to confirm the vehicle title transfer and the operator can offer the telematics subscription services to the caller. If the inference was not correct in indicating vehicle title transfer (this could occur after change of address of the subscriber who forgets to notify the telematics service subscriber), then the operator has an opportunity to update the home address of the subscriber and store the new home address in the in-vehicle unit as in step 40.

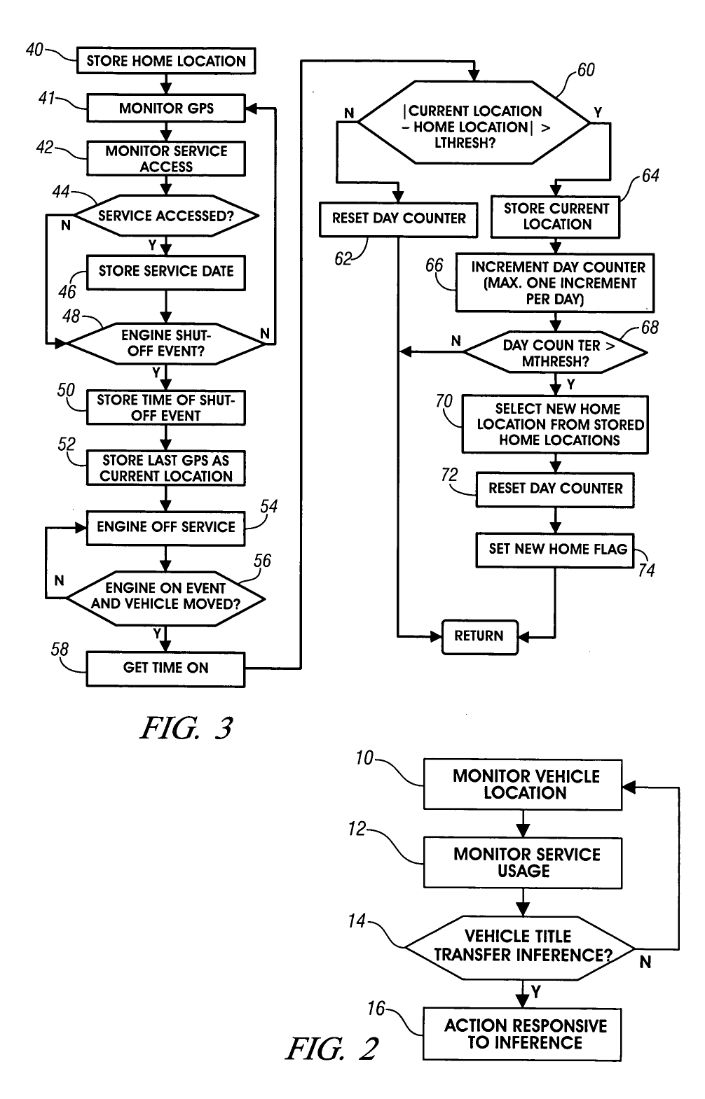

Referring now also to FIG. 2, steps 10-16 begin at step 10, where the vehicle location is monitored. In addition the usage of the telematics service is monitored at step 12.

Step 14 determines whether the location information and usage information indicate inferred title transfer of the vehicle. For example, if the vehicle has a new home location and the telematics service has not been utilized for a predetermined period of time, then an inferred title transfer is indicated. This indication may be the setting of a value in memory of an in-vehicle unit, for example, the telematics unit 32. At step 16, the in-vehicle system takes action if title transfer is inferred. The action taken may be playing of an audio or visual message (or both) indicating to the vehicle user the availability of telematics services. The action may also involve activating other units associated with the vehicle to assist in marketing the telematics services.

Referring now to FIGS. 3-5, example detailed steps for implementing the functions of FIG. 2 can be implemented with in-vehicle software, preferably executed by the processor 38. The process begins at step 40, where the vehicle home location is stored into an in-vehicle unit, preferably the telematics unit. The home location can be obtained a variety of ways, including during vehicle owner subscription for services. In a preferred example, when the telematics service provider learns the home address of the subscriber, it sends, through telematic communications, geo-coded data representing the home address location to the vehicle. The in-vehicle unit stores this information as the HOME LOCATION. This home location is typically that of the original vehicle purchaser. This data is suitable as an input for determining an inference of subsequent vehicle title transfer.

During vehicle operation, step 41 represents monitoring vehicle position, for example utilizing in-vehicle GPS. Step 42 represents monitoring usage of any of the telematics service features. If at step 44 telematics service is utilized, the date of service usage is stored at step 46 and a datum or flag referred to as NEW HOME FLAG (discussed below) is reset.

Next step 48 determines whether or not the vehicle is shut off. If so, step 50 stores the time of shut-off and step 52 stores the most recently detected location information, or, alternatively, obtains and stores updated current location. The location stored at step 52 is referred to as CURRENT LOCATION. Step 54 represents any engine-off service implemented by the telematics system, such as discontinuous receive or interval-based wake-up functions for implementing telematics services. Because shut-off services are not central to this invention and are implemented by known telematics services, they need not be set forth in detail herein.

Next step 56 monitors for a vehicle ignition or engine-on event in combination with movement of the vehicle. Events that involve start-up of the vehicle, but no movement, need not be monitored for the preferred implementation of determining inferences. If the vehicle is started, the on time is detected at step 58.

Step 60 compares CURRENT LOCATION to HOME LOCATION and if they are in the same general location, for example, close enough in geographic location so that the CURRENT LOCATION can be associated with the HOME LOCATION (e.g., it is at or near the same residence or street address), then step 62 resets the variable known as DAY COUNTER and the system returns to step 41. Otherwise, step 64 stores the CURRENT LOCATION in memory and step 66 increments the variable DAY COUNTER, which is set to increment a maximum of once per day.

At step 68, DAY COUNTER is compared to a predetermined threshold MTHRESH, which is set to detect the number of days away from the home location used to infer that the vehicle likely has a new home location—that is, the vehicle is likely operated by a person whose address does not correspond to the home location. In a preferred example, MTHRESH is 45 days, but can be set as the system designer chooses to represent an inference of a new home location. If the DAY COUNTER is not greater than MTHRESH, then the process returns to step 41.

If the DAY COUNTER is greater than MTHRESH, then a move is inferred and step 70 uses the locations stored at step 64 to select a new home location. In a preferred example, the new home location is selected as the most common location stored at step 64 in the most recent MTHRESH number of days. The new home location is stored in memory as the HOME LOCATION.

Step 72 resets the DAY COUNTER and step 74 sets a datum referred to as NEW HOME FLAG.

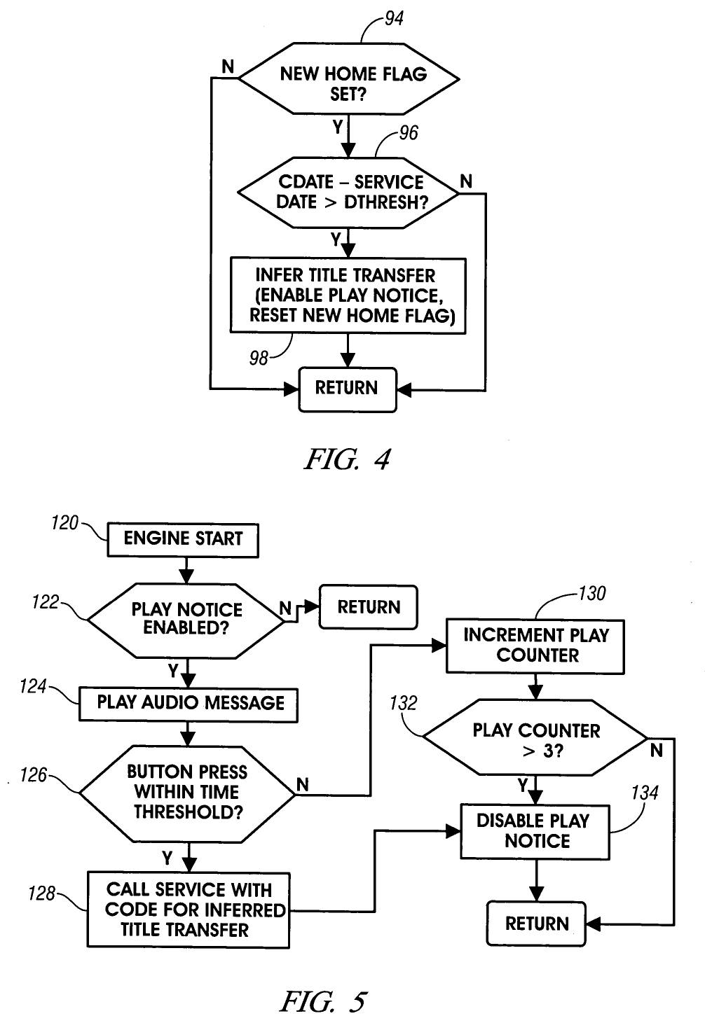

Referring now to FIG. 4, the steps shown utilize the NEW HOME FLAG along with the last service date stored at step 46 in FIG. 3 to determine whether there is an inference of vehicle title transfer. If step 94 detects that the NEW HOME FLAG is set, then step 96 compares the current date to the SERVICE DATE. If the difference between the current date and SERVICE DATE is greater than a threshold DTHRESH, then a title transfer is inferred. An example setting for DTHRESH is 45 days, but can be set to any number of days the system designer chooses to infer non-use because of possible title transfer. If service is used after the change of location is inferred, then there is no need to infer title transfer autonomously in the vehicle because it may be assumed either (1) the user moved but continues to use the system and therefore is likely the same user, or (2) the telematics service provider has had a chance to update the user information and sell new services if desired. When the telematics services provider confirms new subscriber home address, that address can be stored in the same manner as the home location at step 40. This overrides the new home location determined at step 70.

Step 98 signals an inferred title transfer by setting a flag or setting a variable in memory that directly or indirectly triggers action in response to the inferred title transfer. For example, the playing of a notice to the vehicle operator may be signaled as discussed below. Also at step 98, the NEW HOME FLAG is reset.

Referring now to FIG. 5, the steps shown begin at 120 with engine start-up. Step 122 determines whether there is a signal to play a notice to a user in response to an inferred title transfer. If there is, then at step 124 an audio message is played to the vehicle operator. In a preferred example, the audio message indicates that telematics services are available for the vehicle and instructs the vehicle operator how to activate or subscribe to the service, such as by pressing the telematics service button within the vehicle.

At step 126, if the button is not pressed within a predetermined period of time, the play counter is incremented at step 130 and step 132 compares the play counter to its maximum value, for example 3. If the play counter reaches its maximum value, or if the button is pressed at step 126, then the play notice is disabled at step 134. The play counter sets the desired number of times for playing the marketing message, which is preferably played no more than once each vehicle start-up. Once the maximum value is reached, the system terminates playing messages—to avoid having the message continuously played to the new user—until another change of title is inferred.

By using the inferred new home address at step 70 when no other verifiable home address is available, the system can continue to monitor for subsequent inferred title transfers. This way, even if the system is not successful in marketing to, for example, the second owner of the vehicle, it may be successful in marketing to the third owner of the vehicle, etc. Also, the steps for inferring new home address at step 70 can be utilized to infer the original home address if a direct method for obtaining the address and storing it is not achieved.

In the examples described above, the system allows for autonomous marketing to a new vehicle owner with no required disclosure or transfer of data about the vehicle or its new owner without authorization of the new owner.

While, in the preferred example, the action taken responsive to the inference of title transfer includes a marketing message, the action may be any other action suitable for implementation and management of services. One example is to signal a code in memory so that when the vehicle is serviced for maintenance, the maintenance service provider can receive the signal indicating that the vehicle possibly has a new owner and offer appropriate services for a subsequent vehicle owner. One example is complete vehicle preventative inspection, complete fluids check, etc., or for the maintenance service provider to remind the vehicle owner of the availability of telematics services.

Another example is to advise the user of possible termination of the previous subscription contract in response to inference of vehicle title transfer. The previous contract can be terminated if the user does not contact the service provider. This can be accomplished by a connection with the service center communicating inferred title transfer.

1. A telematics service method comprising the steps of:
monitoring vehicle location;
inferring vehicle title transfer responsive to the monitored vehicle location, wherein the monitoring and inferring steps are performed autonomously in the vehicle; and
setting a signal responsive to the inferred vehicle title transfer.

2. A telematics service method comprising the steps of:
first monitoring vehicle location;
second monitoring usage of the telematics service;
inferring vehicle title transfer responsive to the monitored vehicle location and the monitored usage, wherein the first monitoring, second monitoring and inferring steps are performed autonomously in the vehicle; and
setting a value in memory indicative of the inferred vehicle title transfer.

3. A telematics service method comprising the steps of:
monitoring vehicle location;
inferring vehicle title transfer responsive to the monitored vehicle location, and
activating an in-vehicle function in response to the inferred vehicle title transfer.

4. A telematics service method comprising the steps of:
first monitoring vehicle location;
second monitoring usage of a telematics service;
inferring vehicle title transfer from the monitored vehicle location and the monitored usage; and
activating an in-vehicle function in response to the inferred vehicle title transfer.

5. A telematics service method according to claim 3, wherein the activating step comprises playing an audio message.

6. A telematics service method according to claim 5, wherein the audio message is a marketing message for the telematics service.

7. A telematics service method according to claim 6, wherein if a user activates an in-vehicle telematics unit after hearing the audio message, then the in-vehicle telematics unit initiates a coded communication to a service center indicating the inferred title transfer.

8. A telematics service method wherein a vehicle includes functions comprising (a) inferring a vehicle title transfer if (i) the vehicle has been away from a home location for a first predetermined period of time and (ii) telematics services have not been utilized for a second predetermined period of time and (b) activating a response to the inferred vehicle title transfer.

9. A telematics service method according to claim 5, wherein the audio message is a message indicating termination or possible termination of services.

10. A telematics service method according to claim 4 wherein the in-vehicle function includes storing a signal in memory accessible by a vehicle maintenance service provider.

11. A telematics service method according to claim 8, wherein the second predetermined period of time is equal to the first predetermined period of time.
